(19) United States
(12) Patent Application Publication
(10) Pub. No.: US 2003/0070306 A1
(43) Pub. Date: Apr. 17, 2003

(54) Apparatus for supporting a cutting saw about a substrate

(76) Inventor: Jon Anthony McDonald, Woodland Hills, CA (US)

Correspondence Address: Marshall E. Rosenberg, Esq., The Gilbert Law Building, 22130 Clarendon Street, Woodland Hills, CA, 91367, US

(21) Appl. No.: 09/978,460

(22) Filed: Oct. 15, 2001

(51) Int. Cl. B23D 47/02

(52) U.S. Cl. 30/371

(57) ABSTRACT

A supporting roller platform fabricated from a rigid, durable sheet material such as steel or the like configured to receive in cooperating nesting engagement the skid plate of a power cutting tool such as a rotary saw is disclosed. The roller platform is formed with a flat base and a pair of opposing upstanding side walls or tabs formed from outer lateral portions of the base for supporting a plurality of shaft-mounted wheels. An elongated slot is provided in an axially offset, lengthwise direction of the base for receiving a cutting blade of the power tool therethrough as it is extended toward a working, cutting position after being projected through an overlapping axially offset, lengthwise opening provided in the skid plate. The elongated slot is sized and shaped to fully accommodate the cutting blade at any extended position thereof, as well as providing additional space as necessary to allow for airflow and debris removal from the workpiece during operation. Also contemplated by the present invention are alternative configurations of the blade slot, which may be standardized in width, length, and relative lateral position to accommodate the opening of a skid plate, and hence cutting blade extension and operation of commercially available rotary power saws or even of other power tools.

### BACKGROUND OF THE INVENTION

1. Field of the Invention

The present invention relates to cutting saws, and more particularly, to an attachment for supporting and thereby enhancing the use and performance of cutting saws having exposed blades for cutting a substrate.

2. Description of the Related Art

Hand-held power saws having exposed cutting disks or blades with sharpened cutting edges or teeth are commonly used for cutting all manner of stone, masonry, wood and other material that may be provided in block, sheet, slab or other forms. Such saws include rotary saws, band saws, keyhole saws and the like. Powerful, heavy power saws are used to cut concrete, where it is common practice to cut slots or grooves at predetermined intervals in the concrete to serve as stress reliefs during curing and thereafter when the concrete may expand and contract in response to thermal loads provided internally during curing and externally in response to environmental factors. Slots and grooves may be cut through the thickness of the concrete slab to serve as expansion/contraction joints. Alternatively, the slab may be provided with grooves to a subsurface depth, but not the complete depth of the slab for several purposes. One purpose is to serve as scoring lines for separation or demolition purposes. Another purpose is to serve as localized centers for cracking and crazing within the slot so provided, thereby minimizing or preventing the appearance of thermal cracking/crazing at the surface of the slab.

Power saws are also used for shaping and cutting other hard and durable material in sheet, slab or other forms, both natural and artificial, including granite, marble, stone and wood, as well as artificially formed materials including slab or sheet stock of solid surfacing materials commonly used for applications including but not limited to foundations, flooring, counter tops, and roofing. Due to the nature of these applications, conventional power saws are necessarily built with a strong and durable construction, and are hence heavy and cumbersome, requiring significant strength, agility and endurance by the technician or operator for continuing use especially on extended or elaborate projects.

An important problem in the related art is the use of a broad-based skid plate commonly secured to the bottom of virtually all hand-held power saws to serve as a guide plane during use of the cutting tool as well as a resting platform when the tool is not in use. During use, however, the technician must continuously push or drag the saw via the skid plate along the cutting line for essentially the entirety of the cut. Indeed, the skid plate must necessarily remain in substantial contact with the underlying substrate to achieve the desired cut. The nature of this work again requires considerable strength, endurance and precision, and even a slight loss of any of these attributes by the technician or operator typically results in waste and spoilage of the stock material being cut, in addition to the lost labor and commensurate losses in production time and output. This problem is especially acute in the concrete cutting industry, where the substrate being worked is often large cast-in-place slabs for which inaccurate scored relief lines and grooves can materially and negatively affect subsequent construction requirements, and wherein the cutting saws may be of commercial grade with a commensurately greater weight than those saws provided on the consumer retail level. A related problem with the prior art apparatus utilizing skid plates is maintaining an accurate cut when guiding the cutting tool over a surface featuring undulations or other features that challenges the technician or operator in maintaining a perfect cut through the substrate due to the unconstrained nature of the prior art tool whereby the skid plate is prone to follow such irregular surface.

In use, when providing grooves in large slabs and especially concrete and masonry, the saws commonly used include a high-powered, rotating, abrasive saw blade, often lubricated with water such as a water spray directed to the cutting edge. The blade is typically made of diamond abrasive material and is provided with a liquid coolant and lubricant to facilitate cutting the hardened concrete. The resulting heavier hand-held cutting saws, in terms of additional weight and bulk, compound the problems of providing uniform cuts and grooves along the entirety of the surface to be cut.

Accordingly, there exists a need for an apparatus that enhances the use and performance of saws used in all manner of performing cuts, slots and grooves, and overcomes the substantial shortcomings of the prior art.

### OBJECTS AND SUMMARY OF THE INVENTION

Accordingly, it is an object of the present invention to provide an apparatus for supporting a cutting saw to improve operating precision while reducing handling strength requirements of the prior art by substantially eliminating a friction-based skid plate/guidance plane requirement of the prior art.

It is another object of the present invention to provide an improvement for supporting a cutting saw that may be easily and conveniently retrofitted to conventional power tools such as power saws that heretofore required reliance on a skid plate as a guidance plane and support surface.

It is a further object of the present invention to provide an improvement for supporting a cutting saw that provides significant improvements in precision and accuracy of desired cuts made to a substrate, minimizing or eliminating chipping and broken edges resulting from generally unconstrained skid-plate/substrate saws.

It is yet a further object of the present invention to provide an improvement for supporting a cutting saw that provides such precision cutting and eliminating the need for ancillary relief cutting machines thereby.

It is another object of the present invention to provide a cutting saw support improvement that is easily and readily affixed and removed by the professional and amateur alike, and once properly installed with the cutting saw, provides consistent cutting results irrespective of a user's strength or endurance.

It is yet another object of the present invention to provide a precision attachment for supporting a cutting saw, including a rotary power saw, for repeatedly achieving a precise and accurate cut, groove or slot with predetermined physical characteristics, to a substrate

These and other object and advantages are obtained with a supporting roller platform fabricated from a rigid, durable sheet material such as steel or the like configured to receive in cooperating nesting engagement the skid plate of a power cutting tool such as a rotary saw. The roller platform is formed with a flat base and a pair of opposing upstanding side walls or tabs formed from outer lateral portions of the base for supporting a plurality of shaft-mounted wheels. An elongated slot is provided in an axially offset, lengthwise direction of the base for receiving a cutting blade therethrough as it is extended toward a working, cutting position after being projected through an overlapping axially offset, lengthwise opening provided in the skid plate. The elongated slot is sized and shaped to fully accommodate the cutting blade at any extended position thereof, as well as providing additional space as necessary to allow for airflow and debris removal from the workpiece during operation. Also contemplated by the present invention are alternative configurations of the blade slot, which may be standardized in width, length, and relative lateral position to accommodate the opening of a skid plate, and hence cutting blade extension and operation of commercially available rotary power saws or even of other power tools.

The invention will be better understood upon a reading of the following specification, read in conjunction with the accompanying drawings, wherein like reference characters or numbers refer to like parts throughout the description.

### BRIEF DESCRIPTION OF THE DRAWINGS

FIG. 1 is a side elevational view of a rotary cutting saw mounted for use and secured to the supporting roller platform of the present invention, shown in an in situ orientation atop a substrate.

FIG. 2 is a top, plan view of the roller platform of FIG. 1, without the rotary cutting saw mounted thereto, although showing a supporting bar in the fully installed and supported condition.

FIG. 3 is a partial elevational view taken from the left side of FIG. 1, showing the front end of the rotary cutting saw installed and secured to the roller platform, and a rotary cutting blade thereof partly extending downwardly through a cutting slot although in a raised, partially retracted position.

FIG. 4 is a top plan view of a second embodiment of the roller platform of the present invention, showing the unconstructed roller platform.

FIG. 5 is a partial elevational view taken from the left side of FIG. 1, showing the front end of the rotary cutting saw installed and secured to the roller platform, and a rotary cutting blade thereof extending downwardly through a cutting slot into a fully operational, lowered cutting position having a preselected cutting depth based on the extension of the cutting blade.

### DETAILED DESCRIPTION OF THE INVENTION

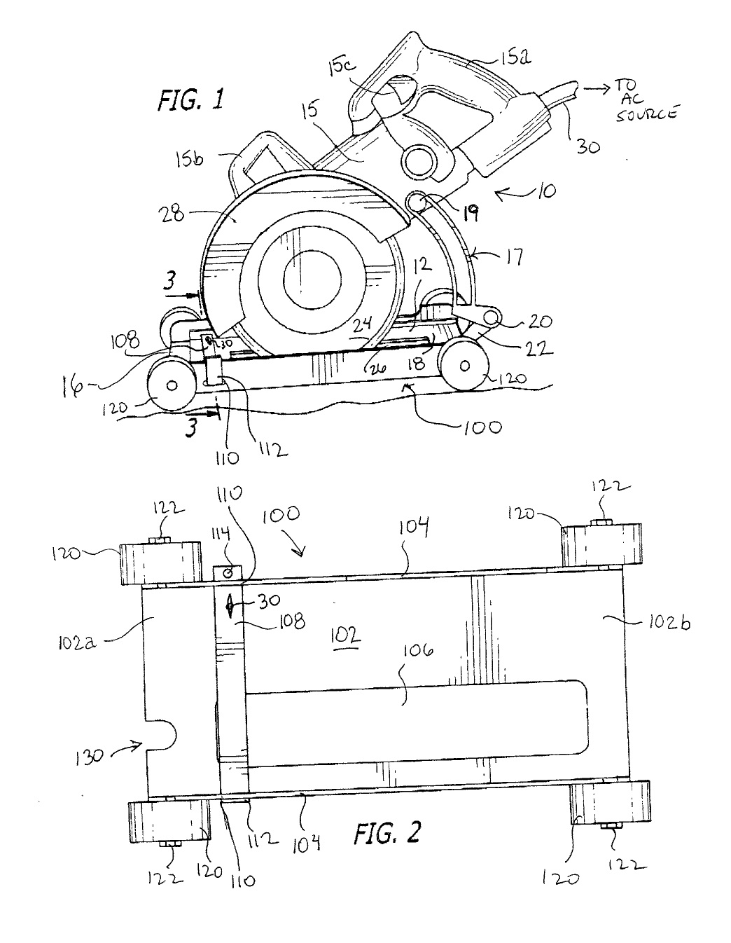

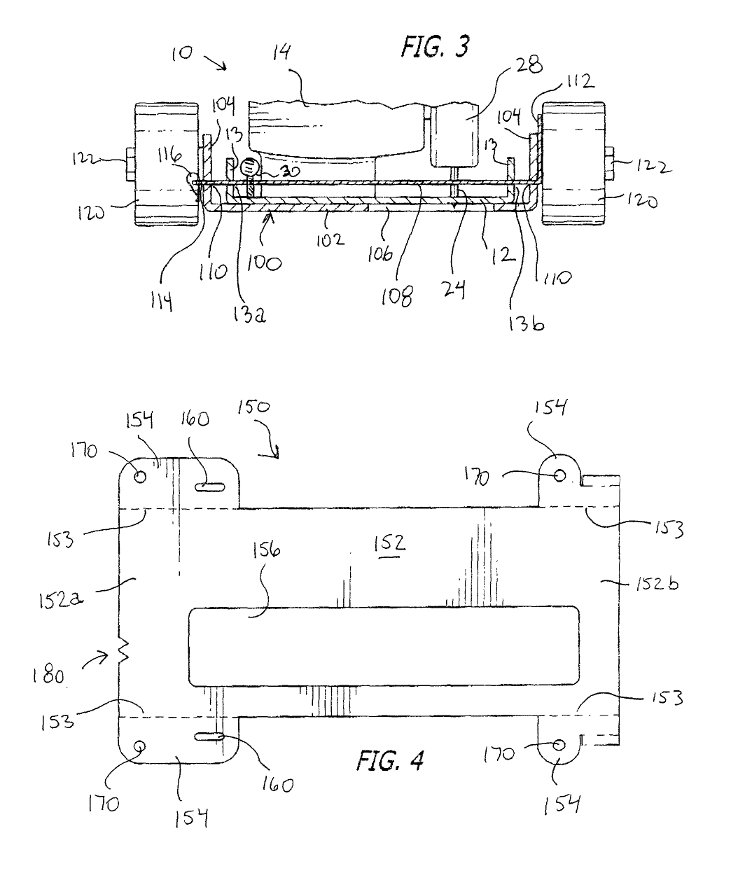

With reference now to the drawings, and according to the present invention, FIGS. 1, 3 and 5 show a cutting tool such as a power rotary saw 10 having a substantially flat, elongated skid plate 12 for mounting a cutting tool motor 14 (FIG. 3) thereto for use with and removably mounted to the supporting roller platform 100 of the present invention, as will be more fully described. Skid plate 12 may optionally include upstanding opposing walls 13 provided at opposite lateral sides thereof (FIG. 3). Cutting tool motor 14 is housed within housing 15 providing primary handle 15a and secondary handle 15b for supporting the saw 10 during use. Primary handle 15a further incorporates a power engagement switch 15c for activating motor 14. The elongated skid plate 12 includes a forward end 16 and a rearward end 18. A slotted, arcuate guide rail 17 supports the housing 15 above the skid plate 12 for adjusting the cutting depth. The upper mounting point is a support pin 19 supported by and extending from the housing 15, and is slidably received along the slotted extent of guide rail 17 as the housing 15 is raised or lowered, and the lower mounting point is pivot 20 further extending to the skid plate 12 via an extension linkage 22.

In use, the housing 15, cutting tool motor 14 and hence cutting blade 24 supported and powered thereby is lowered or raised about a pivot point at the forward end 15 of skid plate 12 to extend or retract the cutting disk or cutting blade 24 through a cutting blade opening 26 provided in the skid plate 12, and is then secured at the desired extension by suitable securing means (not shown) for securing the cutting blade 24 at the desired cutting depth. The cutting disk or cutting blade 24 has cutting characteristics selected for a particular cutting substrate and application. The cutting disk or blade 24 may be partially covered by a safety shield 28 and moves therewith as an extension of housing 15 of cutting tool motor 14. The cutting tool motor 14 may be an electric motor powered by AC power line 30, or alternatively may operated by self-contained battery pack or other source of energy.

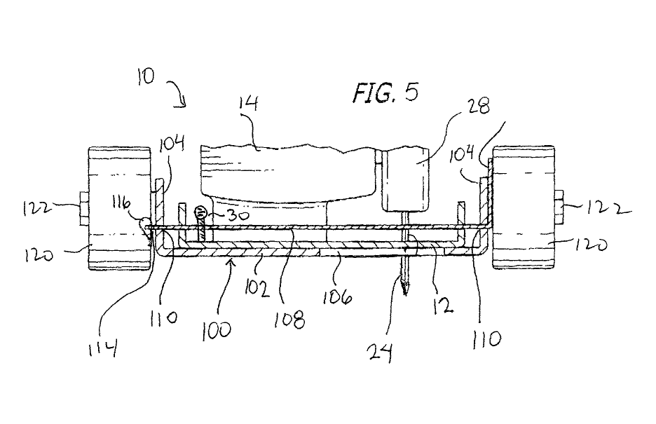

With reference now to FIG. 2, and according to the present invention, supporting roller platform 100 is fabricated from a rigid, durable sheet material such as steel or the like, sufficient to support the weight and working stresses of a power cutting tool as well as absorb without breakage shock, vibration and impacts typically encountered in the construction environment. Roller platform 100 is initially formed with a flat base 102 having a forward end 102a and a rearward end 102b. The roller platform 100 is further provided with two opposing upstanding side walls 104 formed by bending outer lateral portions of the base 102 upwardly to a configuration substantially perpendicular to the plane of the base 102. The supporting roller platform 100 so formed receives and snugly retains the skid plate 12 against substantial transverse motion when the skid plate 12 is brought into a fully nested position within the concavity formed between the base 102 and upstanding side walls 104, with as can be more clearly seen in FIG. 3. Such position is maintained at all times when the cutting blade 24 is in a fully retracted position (FIG. 3) or fully extended position (FIG. 5) and at all positions therebetween.

An elongated slot 106 is provided in an axially offset, lengthwise direction of the base 102 for receiving cutting blade 24 therethrough as it is extended toward a working, cutting position after being projected through an overlapping axially offset, lengthwise opening 26 provided in the skid plate 12. As will be apparent to the skilled artisan, elongated slot 106 is sized and shaped to fully accommodate cutting blade 24 at any extended or angulated position thereof, as well as providing additional space as necessary to allow for airflow and debris removal from the workpiece during operation. Also contemplated by the present invention are alternative configurations of slot 106, which may be standardized in width, length, and relative lateral position to accommodate the opening 26 of skid plate 12, and hence cutting blade extension and operation of commercially available rotary power saws or even of other power tools, such as keyhole saws, routers, and the like.

To stabilize the power saw 10 against forward/backward motion relative to base 102 when mounted therein, a cross-bar 108 is extended through opposing slots 110 formed in upstanding sidewalls 104, thereby capturing the forward end 16 of skid plate 12 in place and preventing such forward/backward relative motion. Cross-bar 108 further includes a side tab 112 formed at one end thereof to limit transverse motion relative to the upstanding sidewalls 104 when brought into juxtaposed position against an outside surface of one upstanding sidewall 104, and a hole or recess 114 formed at the opposite end of cross-bar 108 to be located outside of the opposing upstanding sidewall 104 to accept a retainer pin such as a Cotter pin 116 or other fastener (FIG. 3) after being extended through the corresponding opposing slot 110, and so provided secures the cross-bar 108 in locking position.

Cross-bar 108 further engages slots 13a, 13b provided in opposing walls 13 of skid plate 12 when the saw 10 has been properly received within the base 12, in alignment with slots 110 formed in upstanding sidewalls 104. A thumbscrew 30 is threadably engaged at a lateral extent of the cross-bar 108 to bring the assembly of the skid plate 12 and base 102 into compression and thus secure the front end of saw 10 against undesired vertical motion and vibration during use and transport.

Roller platform wheels 120 are mounted for rotation to shafts 122 supported at forward and rearward portions of sidewalls 104 to support the roller platform 100 for rolling motion in accordance with the objects of the invention. It will be apparent to the skilled artisan that such wheels 120 may be formed with a hard or soft traction surface to accommodate a particular work application, and with outer diameters and wheel widths to provide greater access to challenging or differing work environments. Furthermore, shafts 122 may include quick-release mechanisms to enable easy field replacement. It is further contemplated that shafts 102 may be threaded into blind holes drilled and tapped in sidewalls 104, or may be extended therethrough for securement by fasteners on one or both sides of a sidewall 104. Although not shown, sidewalls 104 may be further provided with additional slots or holes for enabling the technician to install shafted wheels at a selected height relative to the base 102 of roller platform 100, thereby raising or lowering the roller platform 100 as necessitated by a particular application.

An alignment/sight gage such as calibrated cutout 130 is provided at the leading edge of forward end 102a of base 102, linearly situated in front of the saw blade 24 when the power saw 100 is fully installed in the roller base 100.

FIG. 4 shows an alternate embodiment of roller platform 150. According to this embodiment roller platform 100 is fabricated from a rigid, durable sheet material such as steel or the like as previously described, sufficient to support the weight and working stresses of a power cutting tool as well as absorb without breakage shock, vibration and impacts typically encountered in the construction environment. Roller platform 150 is initially formed with a flat base 152 having a forward end 152a and a rearward end 152b. The roller platform 150 is further provided with four corner tabs 154 formed by bending integral outer lateral tab portions of the base 152 upwardly about lines 153 to a configuration substantially perpendicular to the plane of the base 152.

An elongated slot 156 is provided in an axially offset, lengthwise direction of the base 152 for receiving cutting blade 24 therethrough as it is extended toward a working, cutting position after being projected through an overlapping axially offset, lengthwise opening 26 provided in the skid plate 12 in the manner previously described.

To stabilize the power saw 10 against forward/backward motion relative to base 152 when mounted therein, the cross-bar 108 is extended through opposing slots 160 formed in upstanding sidewalls 154, further optionally engaging slots formed in sidewalls extending from skid plate 12, thereby capturing the forward end 16 of skid plate 12 in place and preventing such forward/backward relative motion. Cross-bar 108 further includes a side tab 112 formed at one end thereof to limit transverse motion relative to the upstanding sidewalls 154 when brought into juxtaposed position against an outside surface of one upstanding sidewall 154, and the hole or recess 114 formed at the opposite end of cross-bar 108 to be located outside of the opposing upstanding sidewall 154 to accept a retainer pin such as Cotter pin 166 or the like after being extended through the corresponding opposing slot 160, and so provided secures the cross-bar 108 in locking position in this embodiment.

Roller platform wheels 120 are shaft mounted at mounting points 170 in the manner previously described, at tabs 154 to support the roller platform 150 for rolling motion in accordance with the objects of the invention.

An alignment/sight gage such as calibrated, sawtooth cutout 180 is provided at the leading edge of forward end 152a of base 152, linearly situated in front of the saw blade 24 when the power saw 10 is fully installed in the roller platform 150.

It is to be understood that the present invention is not limited to the embodiments described above, but encompasses any and all embodiments within the scope of the following claims.

1. An apparatus for use with a hand-held power tool having a blade, the power tool secured to a skid plate through which the blade is extendable to engage a workpiece, the apparatus comprising:
a wheeled platform for supporting the power tool by the skid plate above the workpiece without contact between the skid plate and the workpiece, whereby the blade is selectively operationally extended to engage the workpiece.

2. The apparatus as recited in claim 1, further comprising an opening provided in the wheeled platform through which the blade is selectively operationally extended to engage the workpiece.

3. The apparatus as recited in claim 1, wherein the power tool is a power rotary saw having a saw blade.

4. The apparatus as recited in claim 1, wherein the hand-held power tool is removably secured to the wheeled platform, for use independently thereof.

5. The apparatus as recited in claim 1, wherein the wheeled platform comprises:
a platform base for receiving the skid plate of the power tool in a concavity formed therein, and
a plurality of wheels secured for rotation to the platform base for supporting the platform base at a distance from the workpiece.

6. The apparatus as recited in claim 5, wherein the platform base is formed of a sturdy sheet material having a plurality of upturned portions defining the power tool-receiving concavity.

7. The apparatus as recited in claim 6, wherein the upturned portions are opposing lateral portions of the platform base.

8. The apparatus as recited in claim 6, wherein the upturned portions are tabs provided adjacent to each corner of the platform base.

9. The apparatus as recited in claim 5, further comprising a cross-bar extending between and supported by a pair of the opposing portions at a forward end of the platform base to secure a forward end of the skid plate of the power tool.

10. The apparatus as recited in claim 9, wherein the cross-bar is projected through and secured to a corresponding pair of openings formed in the opposing portions.

11. The apparatus as recited in claim 5, further comprising an opening provided in the platform base through which the blade is selectively operationally extended to engage the workpiece.

12. The apparatus as recited in claim 11, wherein the opening is substantially coextensive with a blade opening provided in the skid plate.

13. The apparatus as recited in claim 5, further including an alignment gage adjacent a forward end of the platform base.

14. The apparatus as recited in claim 5, wherein the wheels are optionally removably affixed to the platform base with a quick-release device.

15. The apparatus as recited in claim 5, wherein the platform base is fabricated from sheet steel.

16. An apparatus for use with a hand-held power cutting tool having a cutting device, comprising:
a wheeled platform for supporting the power tool by a skid plate above a workpiece without contact between the skid plate and the workpiece, whereby the cutting device is selectively operationally extended to engage the workpiece.

17. The apparatus as recited in claim 16, wherein the power tool is removably secured by the skid plate to the wheeled platform.

18. The apparatus as recited in claim 17, further comprising an opening provided in the wheeled platform through which the cutting device is selectively operationally extended to engage the workpiece.

19. The apparatus as recited in claim 16, wherein the power tool is a power rotary saw and cutting device is a rotary saw blade.

20. An apparatus for use with a hand-held tool having a material processing portion for processing a workpiece, the hand-held tool supported by a base support portion, the apparatus comprising:
a mobile platform for supporting the hand-held tool by the base support portion during workpiece processing without contact between the base support portion and the workpiece.
